(19) United States
(12) Patent Application Publication
(10) Pub. No.: US 2005/0093675 A1
(43) Pub. Date: May 5, 2005

(54) Process and method of screening an individual at a point of entry to a secure environment to ascertain a risk factor

(76) Inventors: Richard Glee Wood, Houston, TX (US); Wesley Jack White JR., Spring, TX (US)

Correspondence Address: BUSKOP LAW GROUP, P.C., 1717 ST. JAMES PLACE, SUITE 500, HOUSTON, TX, 77056, US

(21) Appl. No.: 10/697,636

(22) Filed: Oct. 30, 2003

(51) Int. Cl. G06F 7/04

(52) U.S. Cl. 340/5.21; 340/5.52

(57) ABSTRACT

A method for providing access and tracking the access of registered and non-registered individuals at a secure point of entry to a secure environment entails an establishing the secure environment by an with an assigned environment Risk Factor; an individual requesting entry into the secured environment at the secure point of entry; sending the individual identifier to an authentication database; receiving a response from the authentication database verifying the individual is non-registered; asking the individual questions to create a profile, assigning a Risk Factor is based upon the profile; registering the individual and Risk Factor on the authentication database; making a comparison between the individual and environment Risk Factor; making a determination whether the individual is allowed entry into the secured environment; and adding the determination to the record of the individual in the authentication database.

### FIELD

Embodiments pertain to methods for providing and tracking access of a registered or a non-registered individual to a secure environment at a point of entry.

Embodiments also pertain to forming a database, such as an authentication database on Risk Factors, for an individual and any associated items and wherein the database can be accessed by a smart card, biometrics reader, and/or other similar identification methods.

### BACKGROUND

The present method is directed to a system and method for monitoring and regulating the entry of individuals to a secure area or secure environment, such as the transportation of people on an airplane or entry into a computer program. Each day, people move into and across the nation, who are likely to cause an act of terrorism. To provide protection against such an act, it is desirable that authorities be able to identify such individuals with certain levels of risk. In order to efficiently guard against potential terrorist attacks, authorities need to be able to detect any unusual or potentially dangerous activity and to notify the appropriate authorities if such activity were to occur.

Currently, the TSA has jurisdiction for most of the laws and regulations that relate to the transportation of people on airplanes in the United States. TSA does not, however, have any national mechanism to track the real-time movement of people, nor does it have any established mechanisms for coordinating information concerning the transportation of high risk people with law enforcement authorities.

Further exacerbating this problem is the lack of a single source of data or regulations regarding criminal individuals or individuals from dangerous countries with known cells of terrorism.

Data and regulations are dispersed between Immigration, police databases, Interpol, the FBI, CIA and state agencies. A need exists to gather this disparately sourced information into a single repository to establish a baseline for tracking these higher risk individuals.

While baggage checks have become common in the airline industry, there has been little or no screening of individuals prior to the boarding process. There have been little developments with access to police and other databases to make a company location secure. A quick method for screening has been needed that more correctly identifies potential terrorists.

### SUMMARY

Embodiments include methods for providing access and tracking the access of a non-registered or registered individual at a secure point of entry to a secure environment. The methods entail an owner establishing a secure environment by an owner with the secure point of entry and an assigned environment Risk Factor. An individual, then, requests entry into the secured environment at the secure point of entry. An identifier signifying the individual is sent to an authentication database. The database notified the owner is the individual is registered or not.

If the individual is not registered, the owner than asks the individual questions in order to produce a profile based on the individual's answers. The owner then assigns the individual a Risk Factor based on the profile. The individual's Risk Factor is compared to the environment Risk Factor in order to ascertain whether the individual is authorized to enter the secured environment. The determination is then recorded in the authentication database.

If the individual is registered, the response from the authentication database also includes the Risk Factor assigned to the individual. The assigned individual Risk Factor is compared with the environment Risk Factor in order to determine whether the individual is granted access to the secured. The record of the determination is sent to the authentication database.

The method also can entail the use of a smart card for entry into the authentication database.

The method also can entail the use of biometric identifiers for entry to the authentication database.

### BRIEF DESCRIPTION OF THE DRAWINGS

The present method will be explained in greater detail with reference to the appended Figures, in which:

FIG. 1 is a schematic of a method for providing access and tracking the access of an non-registered individual at a secure point of entry to a secure environment; and

FIG. 2 is a schematic of method for providing access and tracking the access of a registered individual at a secure point of entry to a secure environment.

The present method is detailed below with reference to the listed Figures.

### DETAILED DESCRIPTION OF THE PREFERRED EMBODIMENTS

Before explaining the present method in detail, it is to be understood that the method is not limited to the particular embodiments herein and it can be practiced or carried out in various ways.

A need has existed for a risk assessment method and system that provides alarms or notification when certain levels of risk are detected for an individual attempting to enter or exit an environment that needs to be secured, namely a secure environment or a secure location. The risk factors are suggested by the definitions below, but additional criteria or elements that are common to immigration, border patrol or police can be inserted or substituted for the items noted below.

Definitions to be used within this process and method include security, secure environment, environment Risk Factor, and individual Risk Factor.

Security refers to methods to control access to a secure environment.

A secure environment can be an airport, a train station, a computer program, a facility such as a building like an office or a warehouse or a parking garage, a country border, a common carrier, like an airplane, a train, a laboratory, a school, a military base, a private company complex, a monument or government building, or similar structures.

Other examples of secured environments include the Pentagon, airports, train stations, bus terminals, sports facilities like stadiums, casinos, hotels, large venue entertainment areas, like the MGM Grand convention complex, large venue trade shows, like the Sands Convention Center in Las Vegas..

The environment Risk Factor is an arbitrary designation associated with a secured environment or location. The environment Risk Factor is assigned by the owner of the secured environment based upon the level of access the owner wishes to maintain in the area. If the secured area is a special laboratory where a company to doing research and development, the owner may want to assign a high environment Risk Factor in order to limit the access to the area only to people with a high clearance code.

The individual Risk Factor is an arbitrary designation associated with a given individual. The individual Risk Factor is compared against the environment Risk Factor in order to determine whether the individual can enter a given location.

The methods contemplate that the individual Risk Factors can be letter designations, number designations, alpha-numeric designations, or similar types assigned values. The individual Risk Factors need to be of the sort that are comparable so a determination can be made as to whether an individual is an authorized individual.

For illustrative purposes, the individual Risk Factors could include four classes: Risk Factor 0, Risk Factor I, Risk Factor II, or Risk Factor III.

A Risk Factor 0 can mean that no designated risk factors assigned to an individual at this time and that the individual is “OK” to proceed into the secure environment. Risk Factor 0 individuals are those who have been assessed for risk, their individual information has been entered into the system and is complete, and it is safe for them to proceed into the secure environment. For individuals who have not yet been assessed for risk they are automatically assigned Risk Factor I, with involves using a set of criteria on the individual in order to enter them into the system.

If the owner did not assign a Risk Factor 0 to the individual, a Risk Factor I could be assigned. The owner would obtain information pertaining to the individual Examples of this type of information can include the individual's name, individual's address, nationality, height, approximate weight, social security number or passport number or government identification type and number, credit card number, a finger print, a digital photo, or age of individual.

If the owner believes the individual carries a risk to the secured area beyond a Risk Factor 0 or I assessment, the owner can assign a Risk Factor II. Risk Factor II assessments would result from the cross comparison of the data entered on the individual to other information and other databases, such as Interpol databases, immigration database, FBI and CIA databases and similar police linked databases.

The information from other databases could include information pertaining to
a. former prison inmate and parole status;
b. times and dates of prior admissions and prior denials to this secure environment or similarly rated secure environments;
c. prior seizures of items prohibited in the secure environment, such as knives, guns, weapons, chemical explosives;
d. “wanted” list information; and
e. pending court judgments.

If any of the above indicators are not clear, the individual is then given a Risk Factor III. When the owner obtains this information, the owner may make the determination that the individual poses a threat to the secured environment and, therefore, assign a Risk Factor II to the individual.

The owner may also inquire about other information pertaining to the individual. The information may be gathered from the authentication database, secondary databases, or by questioning. Topics for questions individuals with a Risk Factor include:
a. questions about the individual's most recent travels;
b. questions pertaining to immigration;
c. questions about the individual's police record and recent arrest;
d. questions about the individual's occupation; and
e. questions about the individual's possessions.

In this example, Risk Factor III means that the owner believes the individual is the highest risk to the secure environment. The owner may require the individual to be held for a search and further questions from government authorities, such as the police or the FBI.

If an individual an acceptable Risk Factor for the secured location and is permitted entry to the secure environment, a smart card or biometric device can be issued to the individual that permits access using the smart card or biometric device for that certain secure environment.

The biometric card is not contemplated for use when the individual is cleared for one secure environment, but not all secured locations. Even with the smart card or biometric device, it is still contemplated that an individual is assigned a risk level for a point of entry so that even if an individual gains entry at one point of entry, they do not gain entry to a second point of entry that may have a higher standard and requires a different evaluation.

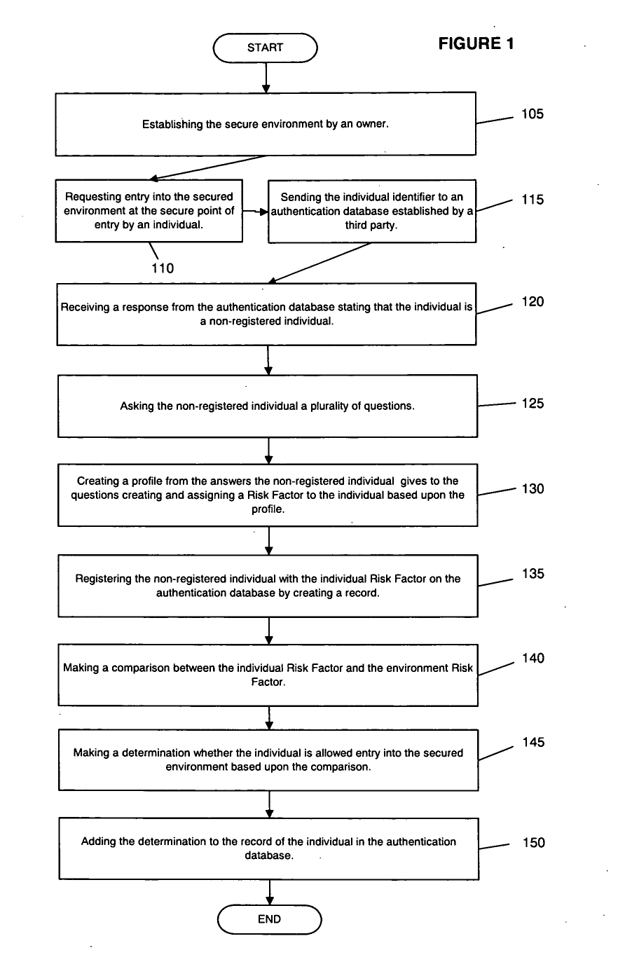

Referring to FIG. 1, an embodiment is a method for providing access and tracking the access of a non-registered individual at a secure point of entry to a secure environment.

The initial step of the method involves the owner establishing the secure environment (105). The secured environment needs a secure point of entry and an environment Risk Factor assigned to the environment. The owner assigns the secured environment an environment Risk Factor based upon the level of security the owner wants for the area.

Next, an individual with an identification information requests entry into the secured environment at the secure point of entry (110). The identification information includes an individual identifier. The identification information can be one or a collection of unique designations that separates one individual from another, such a name, an alpha-numeric code, a fingerprint, or any other biometric characteristic. The individual identifier is the unique designation that is sent to the authentication database in order to verify the identity of the individual.

The individual can request entry into the secured environment by using an interface, such as a fingerprint reader, a numerical code, a voice pattern recognition reader, a retinal scanner, a telemetry card reader, a smart card reader, other biometric readers, or combinations thereof. The individual can also request entry into the secured environment by using a secondary party, such as a secretary, a clerk, an employee, a security guard, a contract worker, or combinations thereof.

Continuing with FIG. 1, the method then entails sending the individual identifier to an authentication database (115). The authentication database is a collection of records for registered individuals stating, at the least, the individual identifier and the assigned Risk Factor. The method contemplates that the authentication database is established by a third party who is neither the individual nor the owner of the secured environment.

The individual identifier can also be cross-referenced as a background check of the individual with other information obtained from various other stored databases via Internet links. The authentication database can be linked to secondary databases, such as Interpol database, United States Border Patrol database; US police database, US FBI database, US CIA database, state agency fingerprint databases, and other state authentication database, immigration databases, or combinations thereof.

The authentication database searches the database for the individual identifier. When the individual identifier is not found, the authentication database sends a response to the owner stating that the individual is a non-registered individual (120).

Continuing with FIG. 1, the method then involves the owner asking the non-registered individual a plurality of questions (125). The individual's answers to the questions produce a profile. The owner then assigns the individual a Risk Factor based upon the profile (130).

If the owner believes that individual poses a great risk, the method contemplates that the individual can be held until additional authorities are notified. Examples of authorites include police, FBI, CIA, Border Patrol, Immigration, Interpol and other police.

The method continues by the owner registering the non-registered individual with the individual Risk Factor on the authentication database (135). Since the individual was not present in the authentication database, this step of the method entails the owner creating a record in the authentication database. At a minimum the record has the individual identifier and the individual Risk Factor. The record can include other information relevant to the individual.

As seen in FIG. 1, the method ends by making a comparison between the individual Risk Factor and the environment Risk Factor (140); making a determination whether the individual is allowed entry into the secured environment based upon the comparison (145); and adding the determination to the record of the individual in the authentication database (150).

In an alternative embodiment of the method, the individual information and identifier is stored on a smart card for entry into the database and the smart card is only usable by the individual with the proper biometric key.

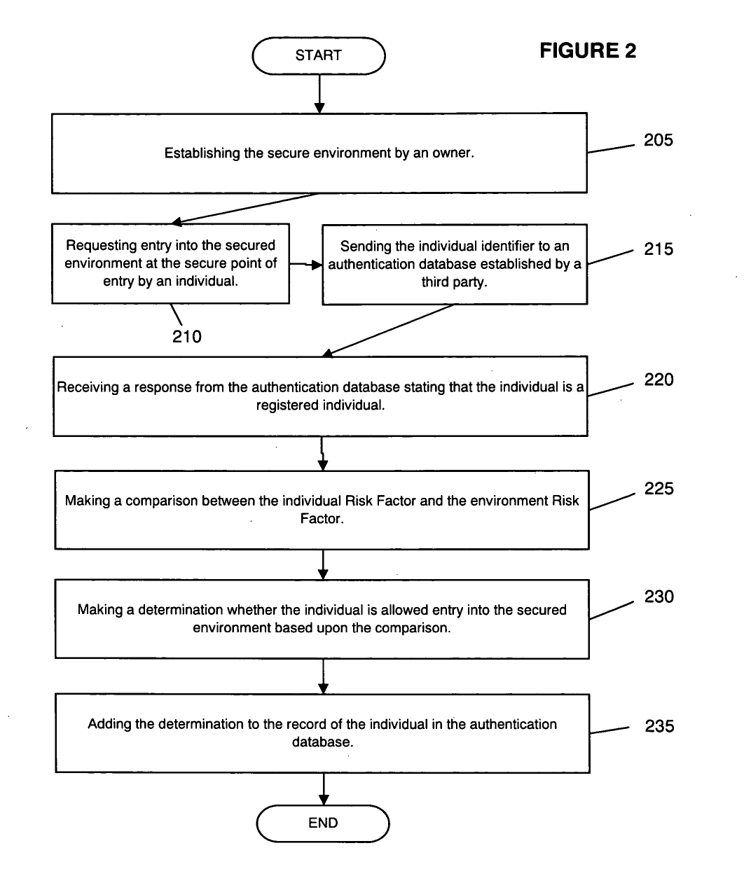

Referring to FIG. 2, an embodiment is a method providing access and tracking of the access of a registered individual at a secure point of entry to a secure environment.

The initial steps of method mirror the embodiment of the method for a non-registered individual. The method entails an owner establishing the secure environment with a secure point of entry and an assigned environment Risk Factor (205) and an individual with an individual identifier requesting entry into the secured environment at the secure point of entry (210).

The individual identifier is sent to the authentication database (215). The individual identifier is checked against the records in the authentication database.

A response is sent to the owner stating that the individual is registered (220). The response also includes the individual Risk Factor assigned to the individual by the owner.

As seen in FIG. 2, the method continues by making a comparison between the individual Risk Factor and the environment Risk Factor (225) and making a determination whether the individual is allowed entry into the secured environment based upon the comparison (230).

In an alternative embodiment, the owner may decide to ask the individual a series of questions in order to create a profile. The owner than may decide to modify the individual Risk Factor assigned to the individual based upon the profile. In addition, the owner can decide that the individual now poses a risk to the secured environment and can hold the individual until additional authorities are notified.

The method ends by adding the determination to the record of the individual in the authentication database (235).

The individual information in the method is stored on a smart card for entry into the authentication database. The smart card is only usable by the individual with the proper biometric key.

The method and process contemplate the authentication database can also include a template for issuing notifications or alarms when an individual does not comply with a Risk Factor assigned to gain entry to a certain secure environment. This template would include:
a. criteria input by an owner or government authority that an individual must meet in order to gain entry to a secure environment, such as
   i. questions asking who an individual represents;
   ii. questions asking what is the purpose of an individual's activity at the secure environment;.
   iii. questions asking for individual information; and
   iv. names of individuals who are granted a Risk Factor 0 and permitted entry;
b. individual information.

The predetermined template used in the method includes criteria used by the owner of the secure environment. The predetermined template can also include a statement or information from a governmental or other authority where the individual is disallowed entry to the secure environment pending a search or questioning. It is contemplated to be within the scope of the method that an owner has a list of persons who are permitted to enter the secure environment.

While this method has been described with emphasis on the preferred embodiments, it should be understood that within the scope of the appended claims the method might be practiced other than as specifically described herein.

1. A method for providing access and tracking the access of a non-registered individual at a secure point of entry to a secure environment comprising:
a. establishing the secure environment by an owner, wherein the secure environment comprises the secure point of entry, and wherein the secure point of entry is assigned an environment Risk Factor;
b. requesting entry into the secured environment at the secure point of entry by an individual, wherein the individual comprises identification information, and wherein the identification information comprises an individual identifier;
c. sending the individual identifier to an authentication database established by a third party, wherein the authentication database comprises records for registered individuals;
d. receiving a response from the authentication database, wherein the response states that the individual is a non-registered individual;
e. asking the non-registered individual a plurality of questions, wherein the non-registered individual answers the plurality of questions creating a profile, wherein an individual Risk Factor is assigned to the individual based upon the profile;
f. registering the non-registered individual with the individual Risk Factor on the authentication database by creating a record comprising the individual identifier and the individual Risk Factor;
g. making a comparison between the individual Risk Factor and the environment Risk Factor;
h. making a determination whether the individual is allowed entry into the secured environment based upon the comparison; and
i. adding the determination to the record of the individual in the authentication database.

2. The method of claim 1, wherein the secure environment is selected from the group consisting of a bank, a computer program, an airport, a train, an airplane, a truck, a military vehicle, a car, a building, offices, an open space, a specified area, a computer, a border of a country, an internal country checkpoint, and combinations thereof.

3. The method of claim 1, wherein the step of requesting entry into the secured environment at the secure point of entry by an individual is performed by a member of the group consisting of a fingerprint reader, a numerical code, a voice pattern recognition reader, a retinal scanner, a telemetry card reader, a smart card reader, other biometric readers, and combinations thereof.

4. The method of claim 1, wherein the steps of requesting entry into the secured environment at the secure point of entry is performed by a secondary party, wherein the secondary party is selected from the group consisting of a secretary, a clerk, an employee, a security guard, a contract worker, and combinations thereof.

5. The method of claim 1, wherein the steps of sending the individual identifier additional information and receiving a response from the authentication database is transmitted by standard voice and data transmission.

6. The method of claim 1, wherein the authentication database is linked to a secondary database, wherein secondary database is selected from the group consisting of Interpol database, United States Border Patrol database, US police database, US FBI database, US CIA database, state agency fingerprint databases, and other state authentication database, immigration databases, and combinations thereof.

7. The method of claim 6, wherein the response from the authentication database further comprises information obtained from the secondary database.

8. The method of claim 1, further comprising the step of holding the individual for questioning when the individual Risk Factor is high, wherein the questioning is performed by a governmental authority or the owner.

9. The method of claim 1, wherein the identification information is selected from the group consisting of fingerprint, a numerical code, a voice sample, an eye scan, individual's name, individual's pictures, individual's demographics, and combinations thereof.

10. The method of claim 1, wherein the step of asking the non-registered individual the plurality of questions comprises asking questions pertaining to individual's immigration; individual's police records; individual's arrests; individual's occupation; individual's possessions; individual's parole status; individual's dates of prior admissions to the secure environment; individual's dates of prior denials to the secure environment; individual's prior seizures of items prohibited in the secure environment; individual's name, individual's address, individual's nationality, individual's height, individual's weight, individual's social security number, individual's passport number, individual's government identification type, individual's government identification number, individual's credit card number, individual's finger print, individual's digital photo, individual's age, and combination thereof.

11. The method of claim 1, further comprising the step of presenting the individual with a smart card after registering the individual in the authentication database, wherein the smart cart comprises the individual identifier.

12. The method of claim 11, wherein the smart card is only usable by the individual with a proper biometric key.

13. A method for providing access and tracking of the access of a registered individual at a secure point of entry to a secure environment comprising:
a. establishing the secure environment by an owner, wherein the secure environment comprises the secure point of entry, and wherein the secure point of entry is assigned an environment Risk Factor;
b. requesting entry into the secured environment at the secure point of entry by an individual, wherein the individual comprises identification information, and wherein the identification information comprises an individual identifier;
c. sending the individual identifier to an authentication database established by a third party, wherein the authentication database comprise records for registered individuals;
d. receiving a response from the authentication database, wherein the response states that the individual is a registered individual, and wherein the response comprises the individual Risk Factor assigned to the individual;
e. making a comparison between the individual Risk Factor and environment Risk Factor;
f. making a determination whether the individual is allowed entry into the secured environment based upon the comparison; and
g. adding the determination to the record of the registered individual in the authentication database.

14. The method of claim 13, further comprising the step of asking the individual a plurality of questions, wherein the individual answers the plurality of questions creating a profile, wherein the individual Risk Factor is modified based upon the profile.

15. The method of claim 14, further comprising the step of holding the individual for questioning when the individual Risk Factor is high, wherein the questioning is performed by a governmental authority or the owner.

16. The method of claim 14, wherein the step of asking the non-registered individual the plurality of questions comprises asking questions pertaining to individual's immigration; individual's police records; individual's arrests; individual's occupation; individual's possessions; individual's parole status; individual's dates of prior admissions to the secure environment; individual's dates of prior denials to the secure environment; individual's prior seizures of items prohibited in the secure environment; individual's name, individual's address, individual's nationality, individual's height, individual's weight, individual's social security number, individual's passport number, individual's government identification type, individual's government identification number, individual's credit card number, individual's finger print, individual's digital photo, individual's age, and combination thereof.

17. The method of claim 1, wherein the steps of sending the individual identifier additional information and receiving a response from the authentication database is transmitted by standard voice and data transmission.

18. The method of claim 1, wherein the authentication database is linked to a secondary database, wherein secondary database is selected from the group consisting of Interpol database, United States Border Patrol database, US police database, US FBI database, US CIA database, state agency fingerprint databases, and other state authentication database, immigration databases, and combinations thereof.

19. The method of claim 18, wherein the response from the authentication database further comprises information obtained from the secondary database.

20. The method of claim 1, further comprising the step of holding the individual for questioning when the individual Risk Factor is high, wherein the questioning is performed by a governmental authority or the owner.

21. The method of claim 1, wherein the identification information is selected from the group consisting of fingerprint, a numerical code, a voice sample, an eye scan, individual's name, individual's pictures, individual's demographics, and combinations thereof.

22. The method of claim 13, further comprising the step of presenting a smart card by the individual requesting entry into the secured environment at the secure point of entry, wherein the smart comprises information specific to the individual.

23. The method of claim 14, wherein the smart card is only usable by the individual with a proper biometric key.
